(19) United States
(12) Patent Application Publication
(10) Pub. No.: US 2002/0121155 A1
(43) Pub. Date: Sep. 5, 2002

(54) Retainer of scooter handle frame

(76) Inventor: Chun-Yi Wu, Tainan (TW)

Correspondence Address: DOUGHERTY & TROXELL, 5205 LEESBURG PIKE, SUITE 1404, FALLS CHURCH, VA, 22041, US

(21) Appl. No.: 09/797,607

(22) Filed: Mar. 5, 2001

(51) Int. Cl. B62K 21/22

(52) U.S. Cl. 74/551.7; 74/551.3

(57) ABSTRACT

A retainer of a scooter handle frame comprises a handle frame, a tightening ring, and a handle rod. After the tightening ring is installed in the handle frame, the handle rod is mounted therein. When a quick detaching device is locked; the quick detaching device will tighten the handle frame and the tightening ring; and thus the sliding trench of the handle frame and the notch of the tightening ring are reduced. As a result, the handle rod is fixed in the handle rod instead of telescopically moving or rotating therein. The contact surface between handle rod and the tightening ring are smooth. When the tightening ring is worn, by the notch, the enlarged size can be compensated. When the tightening ring is destroyed, it is only necessary to update the tightening ring instead of updating the whole handle frame or handle rod so that the cost is reduced.

### BACKGROUND OF THE INVENTION

The present invention relates to a retainer, and especially to a retainer of a scooter handle frame,

The scooter is a novel and popular exercise and is widely used all over the world. One of the reasons is that it has a compact volume after it is folded and has a lightweight so as to be carried conveniently and be stored in a small space. However, how to further reduce the volume is an important object in the development of the scooter. Since the handle frame of a scooter is fixed for a long time and is inconvenient in storage, a telescopic form is developed as illustrated in FIG. 1. A hollow handle frame 1 is illustrated. The inner diameters in various sections of the handle frame 1 are not uniform. Handle rods 10 with different diameters are mounted in the handle frame 1. By the differences of the handle frame 1 and the handle rod 10, it can be telescopically moved and fixed therein. Then a fixing ring 11 is rotated so that it is locked motionless. However, in these structures, since the handle frame and handle rods have different diameters, the manufacturing work is complex. Furthermore, the two are made of metals so as to be worn easily and gaps are formed therebetween so that they are hard to be locked tightly. Furthermore, the handle frame and handle rod are necessary to be updated and therefore, the cost is increased. In telescoping, since the contact surface is coarse, the moving therebetween is not smooth.

### SUMMARY OF THE INVENTION

Accordingly, the primary object of the present invention is to provide a retainer of a scooter handle frame comprises a handle frame, a tightening ring, and a handle rod. The tightening ring is installed in the handle frame. The handle frame is installed with a sliding trench and a notch is installed in the tightening ring. When the quick detaching device is locked, the handle frame and the tightening ring will be tightened to fix the handle rod. Since the tightening ring is moved smoothly, it can be manufactured and updated conveniently.

The various objects and advantages of the present invention will be more readily understood from the following detailed description when read in conjunction with the appended drawing.

### BRIEF DESCRIPTION OF THE DRAWINGS

FIG. 1 is a schematic view of a prior retainer of a scooter handle frame.

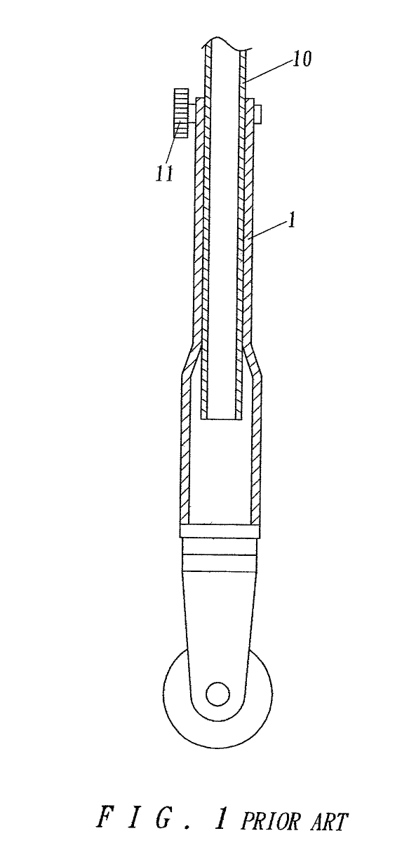

FIG. 2 is an exploded perspective view of the present invention.

FIG. 3 is an assembled perspective view of the present invention.

FIG. 4 is a schematic view showing the positioning of the handle rod in the present invention.

FIG. 5 is an assembled schematic view of the present invention.

FIG. 6 is a schematic view showing the quick detaching device of the present invention being tightened.

FIG. 7 is a schematic view showing the quick detaching device of the present invention being loosed.

FIG. 8 is a schematic view showing that the tightening ring of the present invention is worn.

FIG. 9 is a schematic view showing that the tightening ring of the present invention is reduced to compensate the expansion of the gap in radial direction.

### DETAILED DESCRIPTION OF THE PREFERRED EMBODIMENTS

In order that those skilled in the art can further understand the present invention, a description will be described in the following in details. However, these descriptions and the appended drawings are only used to cause those skilled in the art to understand the objects, features, and characteristics of the present invention, but not to be used to confine the scope and spirit of the present invention defined in the appended claims.

The object of the present invention is to provide a retainer of a scooter handle frame which can be made easily, telescopically quickly, repaired and conveniently.

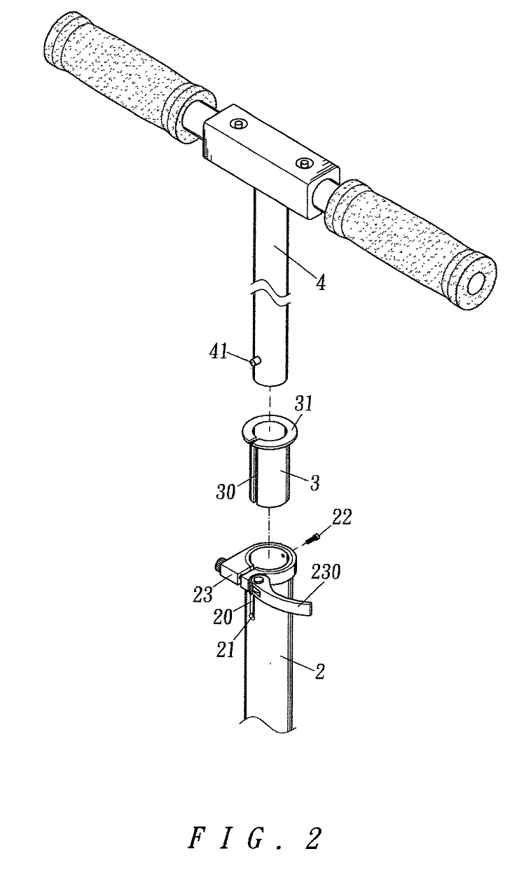

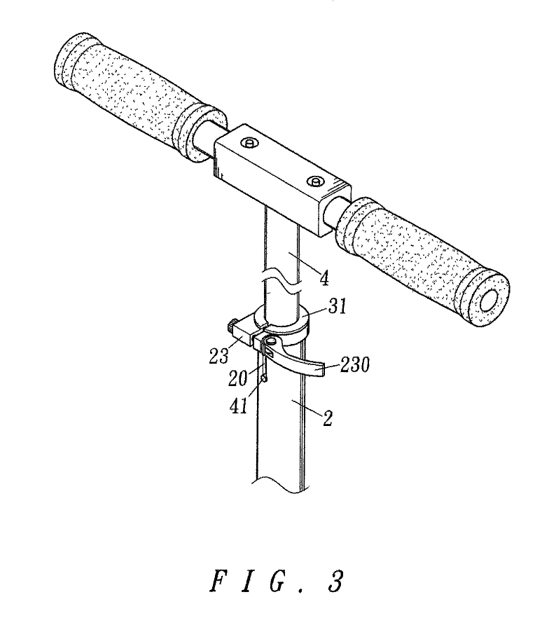

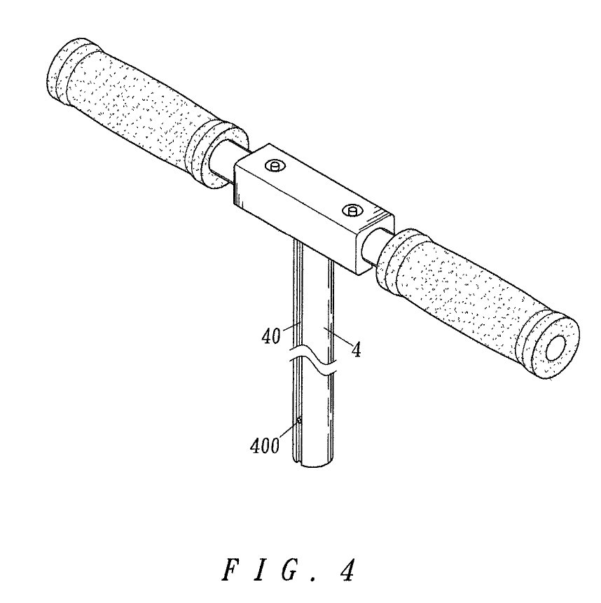

At first, referring to FIGS. 2 and 3, the retainer of a scooter handle frame is illustrated. In the present invention, a handle frame 2 as a hollow tube is installed. The top end of the handle frame 2 is installed with a sliding trench 20. The distal end of the sliding trench 20 is installed with an embedding trench 21. A positioning post 22 is mounted on the handle frame 2 at a back surface with respect to the sliding trench 20. The outer edge of the top of the handle frame 2 is tightly enclosed by a quick detaching device 23 (known in the prior art, and thus the details will not be described here). A movable handle 230 serves to control the releasing or tightening of the quick detaching device 23. A tightening ring 3 is installed in the handle frame 2. The tightening ring 3 is made of plastic material (for example plastics). A notch 30 is formed in the tightening ring 3. A top of the tightening ring 3 is enclosed by the stopper 31. The tightening ring 3 is resisted against the top of the handle frame 2 by the stopper 31 so that the tightening ring 3 is fixed not to be wholly embedded into the handle frame 2. A handle rod 4 is installed within the handle frame 2 and the tightening ring 3. The surface of the handle rod 4 with respect to the positioning post 22 of the handle frame 2 is formed with a positioning groove 40 (referring to FIG. 4). A pin 400 is installed at a proper position of the positioning groove 40. The positioning groove 40 resists against the positioning post 22 in the handle frame 2 so that as the handle rod 4 is telescopically moved in the handle rod 4, it neither rotates, nor shifts. By the resisting effect of the pin 400, the handle rod 4 will not release out of the handle frame 2. A bottom of the handle rod 4 with respect to the embedding trench 21 of the handle frame 2 is installed with an embedding post 41 which can be pressed elastically. The embedding post 41 is slidable in the sliding trench 20 and can be embedded in the embedding trench 21 so as to be fixed therein.

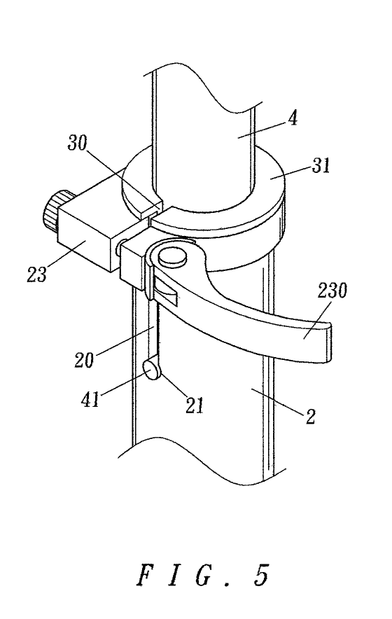

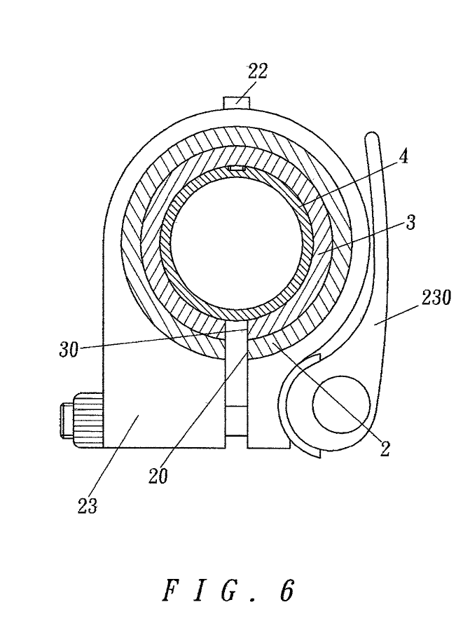

In assembly, referring to FIG. 5, the tightening ring 3 is installed in the handle frame 2 so that the notch 30 of the tightening ring 3 is at the same line with the sliding trench 20 of the handle frame 2, and then the bottom end of the handle rod 4 is inserted from the top of the handle frame 2 so that the embedding post 41 of the handle rod 4 is exactly embedded into the embedding trench 21 of the handle frame 2 to be fixed therein. Furthermore, the positioning post 22 of the handle frame 2 is positioned in the positioning groove 40 of the handle rod 4 so that as the handle rod 4 is telescopically moved, it will not rotate. Then the movable handle 230 of the quick detaching device 23 is moved, so that the quick detaching device 23 will tighten the handle frame 2 and the tightening ring 3 (referring to FIG. 6) and thus the sliding trench 20 of the handle frame 2 and the notch 30 of the tightening ring 3 are reduced because of being pressed. As a result, the handle rod 4 is fixed in the handle frame 2 instead of telescopically moving or rotation.

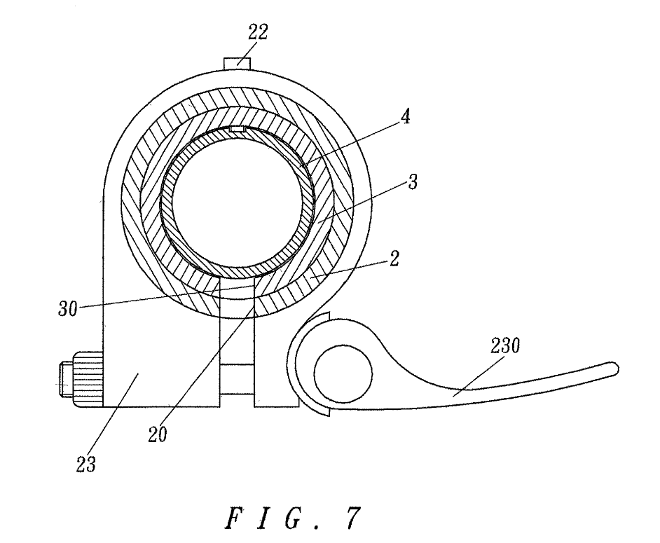

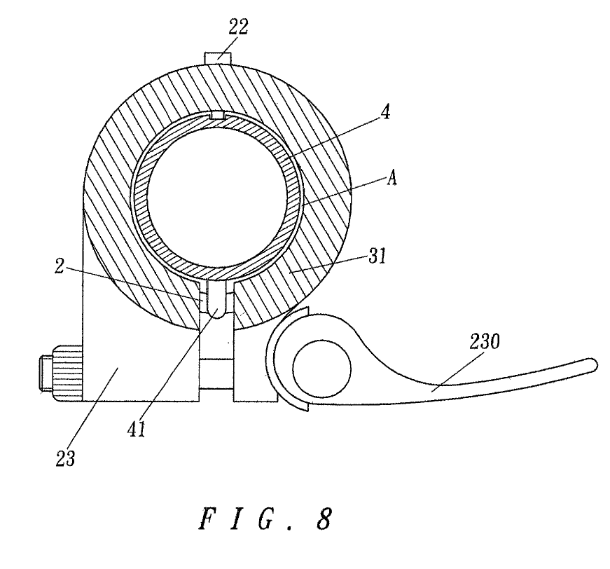

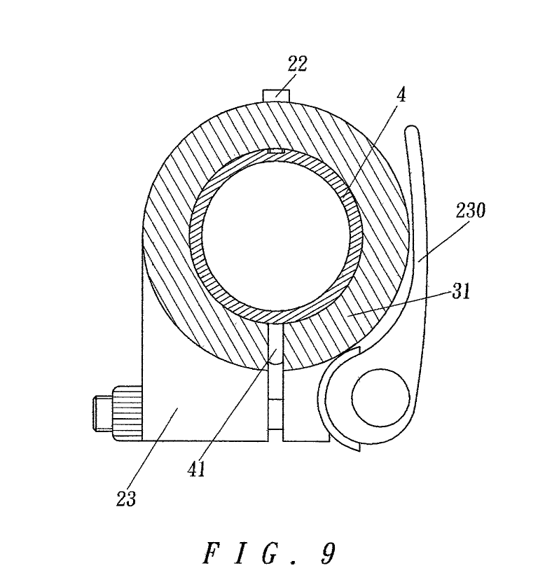

As it is desired to be detached, referring to FIG. 7, it is only necessary to loose the movable handle 230 of the quick detaching device 23, then pressing the embedding post 41 of the handle rod 4 to release from the buckling of the embedding trench 21. Then, the handle rod 4 can be pushed downwards and then is reduced. Then the movable handle 230 is moved to lock the quick detaching device 23 as to be reduced and then is fixed therein. When the handle rod 4 slides, it will contact the contact surface of the tightening ring 3. Since the interior of the tightening ring 3 is smooth, flat and elastic, the handle rod 4 will smoothly move therein. If the tightening ring 3 is worn so that the enlarged gap A in the radial direction is enlarged (referring to FIG. 8), the tightening ring 3 will be compensated (referring to FIG. 9). When the tightening ring 3 is destroyed, it is only necessary to update the tightening ring 3 instead of updating the whole handle frame 2 or handle rod 4. Therefore, the cost can be controllable effectively. The handle frame 2 and handle rod 4 are radially aligned without any machining work, and thus the manufacturing work is convenient.

From the aforesaid description, it is known that the present invention has the following advantages:

1. Since the handle frame 2 is installed with a sliding trench 20, and the tightening ring 3 is installed with notch 30, when the quick detaching device 23 is locked tightly, it can be pressed rapidly to be compressed so that the handle rod 4 is fixed.

2. The contact surface between handle rod 4 and the tightening ring 3 is smooth, as it is reduced, it will move successfully. When the tightening ring 3 is worn, by the notch 30, the enlarged size can be compensated.

3. The present invention can be conveniently assembled. When the tightening ring 3 is destroyed, it is only necessary to update the tightening ring 3 instead of updating the whole handle frame 2 or handle rod 4 so that the cost is reduced.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A retainer of a scooter handle frame comprising:
a handle frame as a hollow tube; a top end of the handle frame being installed with a sliding trench; a distal end of the sliding trench being installed with an embedding trench; a positioning post being mounted on a surface of the handle frame; an outer edge of a top of the handle frame being tightly enclosed by a quick detaching device; a movable handle serving to control the releasing or tightening of the quick detaching device;
a tightening ring installed in the handle frame; a notch being formed in the tightening ring; and a top of the tightening ring being enclosed by the stopper;
a handle rod being installed within the handle frame and the tightening ring; a surface of the handle rod being formed with a vertically positioning groove; a pin being installed at the positioning groove; a bottom of the handle rod being installed with an embedding post which can be pressed elastically.
